(19) United States
(12) Patent Application Publication
(10) Pub. No.: US 2012/0057259 A1
(43) Pub. Date: Mar. 8, 2012

(54) CONTROLLER WITH BATTERY RECHARGE PROTECTIVE FUNCTION

(75) Inventors: Yang YANG, Wuxi (CN); Hai-Po LI, Wuxi (CN); Li-Min LEE, Taipei County (TW)

(73) Assignee: GREEN SOLUTION TECHNOLOGY CO., LTD., Taipei County (TW)

(21) Appl. No.: 12/958,425

(22) Filed: Dec. 2, 2010

(30) Foreign Application Priority Data
Sep. 6, 2010 (CN) 201010275197.1

(51) Int. Cl. H02H 9/04; H02H 9/02

(52) U.S. Cl. 361/56; 361/57

(57) ABSTRACT

A controller with battery recharge protective function is disclosed in this invention. The controller is used for protecting a battery module. When the battery module is in a protective state, a recharge protection circuit of the controller is activated. A charging current from a positive recharge terminal flows into one pin of the controller. Afterward, the charging current passes the recharge protection circuit, flows out through another pin of the controller, and then returns to a negative recharge terminal. Accordingly, the recharge protection circuit makes the charging current bypass the battery module, so as to prevent the battery module from being damaged.

### RELATED APPLICATIONS

This application claims priority to China Application Serial Number 201010275197.1, filed Sep. 6, 2010, which is herein incorporated by reference.

### BACKGROUND

1. Field of Invention

The present invention relates to a control circuit. More particularly, the present invention relates to a controller with battery recharge protective function.

2. Description of Related Art

With the progressing of electronic technology and consumer electronic products, various portable electronic devices are widespread recently. A high-quality power supply is one of the major factors of the mobility, performance and durability of the portable devices. Most portable devices right now depends on battery modules for supplying electricity.

The commercially available battery modules include non-rechargeable battery, rechargeable battery and fuel battery types. The rechargeable batteries are more common in consumer electronic products, because the rechargeable batteries can be more economical and environmental friendly. The material inside the rechargeable battery can be recovered to its original state during a recharging process, such that the rechargeable battery can be repeatedly used. Lead acid battery, nickel cadmium battery, nickel hydrogen battery, lithium battery, lithium ion battery are most common examples of the rechargeable batteries.

However, the safety and durability of battery is directly related to the operating habit of users. For example, when the user accidentally leaves a lithium ion battery on a recharging stand over a long time, the lithium ion battery will be over-charged, and it will boost the temperature of the battery. In this case, the over-heated battery may have problems of electrolyte decomposition, high internal pressure and lithium leakage, which may even lead to dangers of heavy metal pollution, crack and fire. On the other hand, when the lithium ion battery is over-discharged, the battery may be damaged and unable to recharge in normal procedure.

To avoid the safety problems in recharging procedure and degradation of battery capacity, some controllers (e.g. control circuit or control chip) are developed for implementing into the battery or the recharging apparatus. The controller may detect the power level of the battery module and perform corresponding actions (e.g. recharge monitoring, overcharge interrupt protection, etc). Please refer to FIG. 1, which illustrates a controller 100 within a recharging apparatus in prior art. The controller 100 includes a voltage detection unit 101, a control logic unit 102 and a current detection unit 103.

The voltage detection unit 101 is coupled to two terminals of a battery module 200, for monitoring a voltage state of the battery module 200. For example, the voltage detection unit 101 is configured to detect the voltage level difference between two terminals of the battery module 200, and accordingly the control logic unit 102 may acknowledge the state of the battery module 200. The battery module 200 is connected to a recharge apparatus via a positive recharge terminal 203 and a negative recharge terminal 204. When the battery module 200 is fully charged, the control logic unit 102 may switch off a recharge switch unit 201 within the recharge apparatus, so as to interrupt the recharge loop L1 from the battery module 200 to the negative recharge terminal 204 for avoiding some potential threats.

To be noticed that, even though the external recharge loop L1 from the battery module 200 to the negative recharge terminal 204 is interrupted, there may still exist another loop inside the controller 100, such that a leakage current may keep on charging the battery module 200 although the protection function in prior art is activated.

For example, the controller 100 in prior art may include a sampling switch unit 104 and a sampling resistor 105 for voltage adjustment (e.g. voltage pull-high or pull-low). The sampling switch unit 104 and the sampling resistor 105 provide a current sampling node 103a required by the current detection unit 103, which can be used for determining whether switching the recharge switch unit 201 from off-mode back to on-mode. The sampling switch unit 104 has a parasitic diode 104a. When the battery module is under over-charge state, even though the external recharge switch unit 201 is off to interrupt the external recharge loop L1, there is still a leakage current flowing through the internal loop L2 (i.e. via the parasitic diode 104a of the sampling switch unit 104, and the sampling resistor 105). The leakage current is existed because the level of the negative recharge terminal 204 is lower than the negative terminal of the battery module 200, and the level of the current sampling node 103a is approximately equal to the level of the negative recharge terminal 204. Therefore, the level of the current sampling node 103a is lower than the negative terminal of the battery module 200. The leakage current may continuously recharge the battery module 200, such that it may disable over-charge protection of the controller 100 in prior art and cause some potential threat.

### SUMMARY

In order to solve the aforesaid problem of leakage current and continuing over-charge, the goal of the invention is to provide a controller which may utilize a current-guiding mean to make sure that the leakage current bypasses the battery module, or utilize a voltage-clamping mean to prevent the unwanted current leakage. Therefore, the safety in battery recharge procedure can be ensured.

An aspect of the invention is to provide a controller with battery recharge protective function, which includes a first pin, a second pin, a third pin and a recharge protection circuit. The first pin is coupled to a positive recharge terminal. The second pin is coupled to a positive terminal of a battery module. The third pin is coupled to a negative terminal of the battery module. The recharge protection circuit is coupled to the first pin and the third pin. When the battery module is in a protective state, the recharge protection circuit is activated, such that an in-flowing current at the first pin goes through the recharge protection circuit and out-flows via the third pin.

According to an embodiment of the invention, the recharge protection circuit includes a voltage-clamping unit. When the recharge protection circuit is activated, the voltage-clamping unit clamps a level of the first pin to be equal to or lower than a sum of a level of the second pin and a predetermined level difference, wherein the predetermined level difference is positive.

According to another embodiment of the invention, the controller with battery recharge protective function further includes an electrostatic discharge protection circuit coupled between the first pin and the second pin.

Another aspect of the invention is to provide a controller with battery recharge protective function. The controller includes a first pin, a second pin, a third pin and a recharge protection circuit. The first pin is coupled to a negative recharge terminal. The second pin is coupled to a positive terminal of a battery module. The third pin is coupled to a negative terminal of the battery module. The recharge protection circuit is coupled to the first pin and the second pin. When the battery module is in a protective state, the recharge protection circuit is activated, such that an out-flowing current at the first pin in-flows from the second pin and goes through the recharge protection circuit, so as to out-flow via the first pin.

According to an embodiment of the invention, the recharge protection circuit includes a voltage-clamping unit. When the recharge protection circuit is activated, the voltage-clamping unit clamps a level of the first pin to be equal to or higher than a level of the third pin minus a predetermined level difference, wherein the predetermined level difference is positive.

According to another embodiment of the invention, the controller further includes an electrostatic discharge protection circuit coupled between the first pin and the third pin.

Another aspect of the invention is to provide a controller with battery recharge protective function. The controller includes a first pin, a second pin, a third pin and a voltage-clamping circuit. The first pin is coupled to a positive recharge terminal. The second pin is coupled to a positive terminal of a battery module. The third pin is coupled to a negative terminal of the battery module. The voltage-clamping circuit is coupled to the first pin and the third pin. The voltage-clamping circuit is configured to maintain a level of the first pin to be equal to or lower than a sum of a level of the second pin and a predetermined level difference, wherein the predetermined level difference is positive.

According to an embodiment of the invention, the voltage-clamping circuit includes a voltage-clamping unit and a switch unit. The switch unit is switched-on when the level of the first pin is higher than the level of the second pin plus the predetermined level difference.

According to another embodiment of the invention, an in-flowing current at the first pin goes through the voltage-clamping circuit and out-flows via the third pin when the switch unit is switched-on.

Another aspect of the invention is to provide a controller with battery recharge protective function. The controller includes a first pin, a second pin, a third pin and a voltage-clamping circuit. The first pin is coupled to a positive recharge terminal. The second pin is coupled to a positive terminal of a battery module. The third pin is coupled to a negative terminal of the battery module. The voltage-clamping circuit is coupled to the first pin and the second pin. The voltage-clamping circuit is configured to maintain a level of the first pin to be equal to or higher than a level of the third pin minus a predetermined level difference, wherein the predetermined level difference is positive.

According to an embodiment of the invention, the voltage-clamping circuit includes a voltage-clamping unit and a switch unit. The switch unit is switched-on when the level of the first pin is lower than the level of the third pin minus the predetermined level difference.

According to an embodiment of the invention, when the switch unit is switched-on, an out-flowing current at the first pin in-flows from the second pin and goes through the recharge protection circuit, so as to out-flow via the first pin.

The advantages of the embodiment in the invention is to ensure that the battery module and the controller are free from unexpected current or voltage signal by utilizing a current-guiding mean to make sure the leakage current bypass the battery module, or utilizing a voltage-clamping mean to prevent the unwanted current leakage. Therefore, the safety and durability in battery recharge procedure can be ensured.

### BRIEF DESCRIPTION OF THE DRAWINGS

The invention can be more fully understood by reading the following detailed description of the embodiment, with reference made to the accompanying drawings as follows:

FIG. 1 is a block diagram illustrating a controller within a recharging apparatus in prior art;

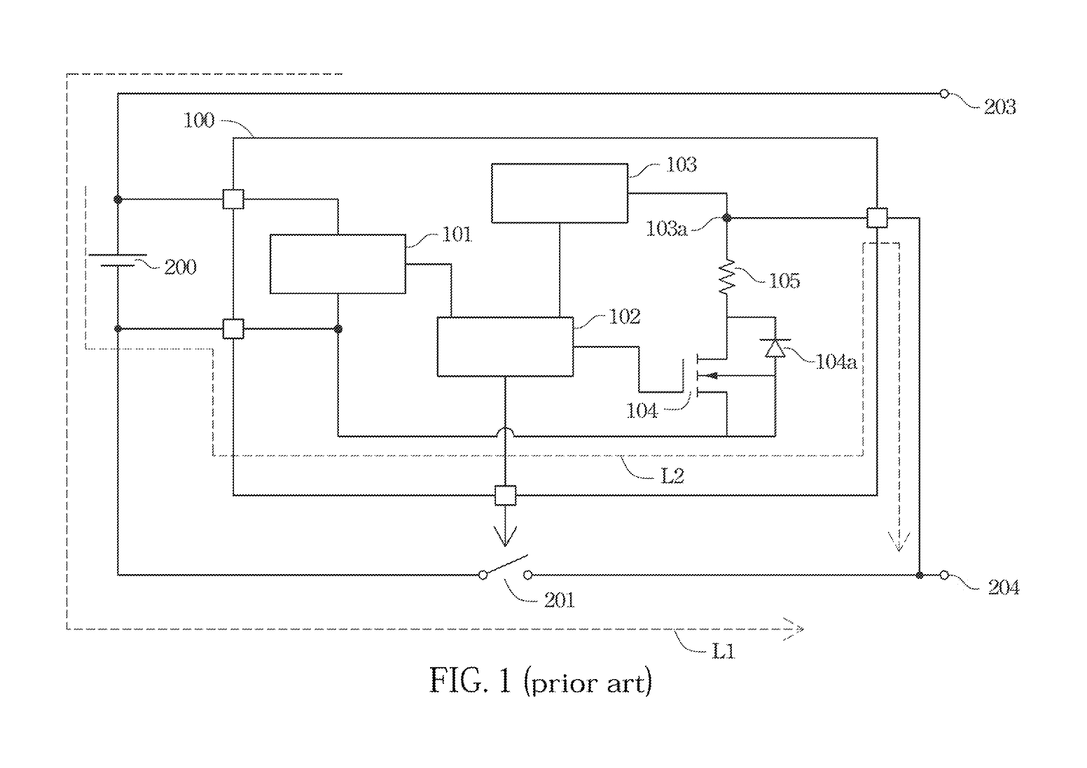

FIG. 2A is a block diagram illustrating a controller for protecting a battery module according to an embodiment of the invention;

FIG. 2B is a block diagram illustrating a controller according to a second embodiment of the invention;

FIG. 3A is a block diagram illustrating a controller for protecting a battery module according to a third embodiment of the invention; and

FIG. 3B is a block diagram illustrating a controller for protecting a battery module according to a fourth embodiment of the invention.

### DETAILED DESCRIPTION

To achieve aforesaid advantages and solve aforesaid problems in prior art, the controller in the embodiments of the invention implements a current-guiding and/or voltage-clamping circuit for preventing the negative effects caused by unexpected current or voltage signals. The detail descriptions of implementation are demonstrated in following paragraphs.

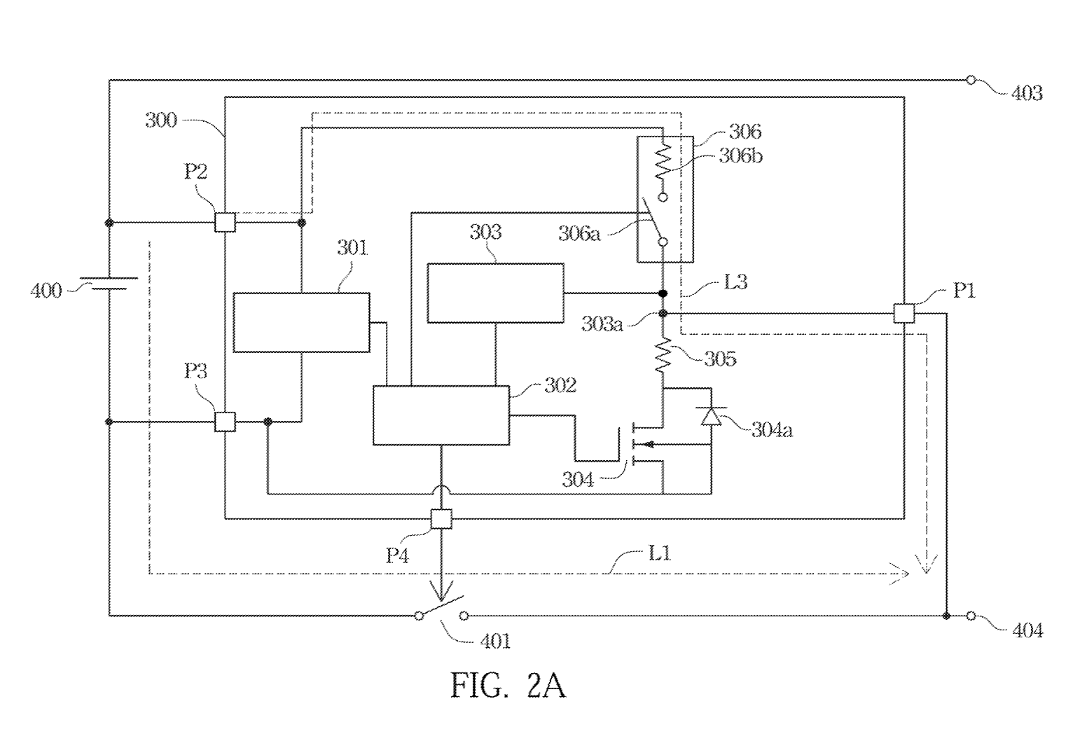

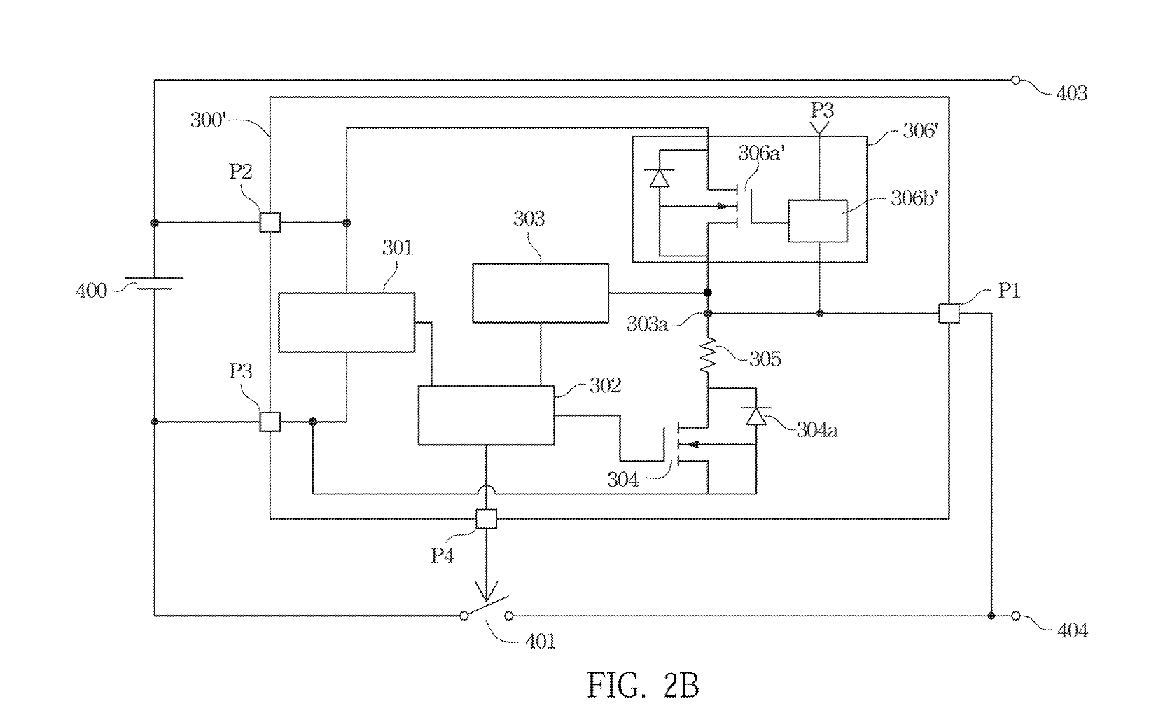

Please refer to FIG. 2A, which is a block diagram illustrating a controller 300 for protecting a battery module 400 according to an embodiment of the invention. When the battery module 400 is connected to a household power outlet or a specific recharge apparatus for recharging, the controller is used for protecting the battery module 400. In practical applications, the controller 300 can be a control chip or a control unit, which can be integrated with the specific recharge apparatus, the household power outlet or the battery module 400. However, the invention is not limited to this. In some other cases, the controller 300 may also be an independent apparatus.

As shown in FIG. 2A, a positive terminal of the battery module 400 is coupled to a positive recharge terminal 403 of the household power outlet or the specific recharge apparatus, and a negative terminal of the battery module 400 is coupled to a negative recharge terminal 404 of the household power outlet or the specific recharge apparatus, so as to form a recharge loop (i.e. the external recharge loop L1 in FIG. 2A). A recharge switch unit 401 can be disposed on the recharge loop. The recharge switch unit 401 is used for switching on/off the external recharge loop L1 from the battery module 400 to the negative recharge terminal 404.

In the embodiment, the controller 300 has an outward connection interface including a first pin P1, a second pin P2, a third pin P3 and a fourth pin P4. The first pin P1 is coupled to the negative recharge terminal 404. The second pin P2 is coupled between a positive terminal of the battery module 400 and the positive recharge terminal 403. The third pin P3 is coupled between the negative terminal of the battery module 400 and the recharge switch unit 401. The fourth pin P4 is used for controlling the recharge switch unit 401.

Besides, the controller 300 may includes a voltage detection unit 301, a control logic unit 302, a current detection unit 303 and a recharge protection circuit 306.

The voltage detection unit 301 is coupled to two terminals of a battery module 400 via the second pin P2 and the third pin P3, for monitoring a voltage state of the battery module 400 and judging if a protective action is needed. For example, the voltage detection unit 301 is configured to detect the voltage level difference between two terminals of the battery module 400, and accordingly the control logic unit 302 may acknowledge the state of the battery module 400 (e.g. the battery module 400 is fully charged, or the battery module 400 is over-discharged). When the battery module 400 is fully charged or over-discharged, the control logic unit 302 may switch off a recharge switch unit 401 via the fourth pin P4, so as to interrupt the recharge loop L1 from the battery module 400 to the negative recharge terminal 404, and accordingly to prevent from recharging the battery module 400 which has been fully charged or over-discharged already.

In the embodiment, the controller 300 may further include other internal operational circuits. To be noticed that, part of the internal operational circuits (e.g. a sampling switch unit 304 and a sampling resistor 305 in FIG. 2A) may be coupled between the first pin P1 and the third pin P3.

In this case, even though the external recharge loop L1 is interrupted, the operational circuits between the first pin P1 and the third pin P3 inside the controller 300 forms another loop (e.g. through a parasitic diode 304a of the sampling switch unit 304 and the sampling resistor 305), which causes over-charging issue to the battery module 400.

To be noticed that, the recharge protection circuit 306 of the controller 300 in the embodiment can be utilized to solve aforesaid issue. The recharge protection circuit 306 is coupled to the first pin P1 and the second pin P2_{[H1]}. When the battery module 400 is in a protective state, the recharge protection circuit 306 is activated to correspondingly protect the battery module 400. In this embodiment, the so-called protective state is existed when the voltage detection unit 301 detects that the voltage level difference between the second pin P2 and the third pin P3 exceeds a specific first voltage value (e.g. the nominal voltage of the battery module 400, representing the battery module 400 is fully charged), or the voltage level difference between the second pin P2 and the third pin P3 is lower than a second voltage value (representing the battery module 400 is over-discharged).

When the battery module 400 is in the protective state, the control logic unit 302 activates the recharge protection circuit 306, such that an in-flowing current at the second pin P2 (which is coupled to the positive terminal of the battery module 400) goes through a switch unit 306a and a resistor 306b of the recharge protection circuit 306, and then the current flows out via the first pin P1 back to the negative recharge terminal 404 (shown as the current-guiding loop L3 in FIG. 2A). In this way, the recharging current from the positive recharge terminal 403 skips the battery module 400 and is guided through the second pin P2, the recharge protection circuit 306, the first pin P1 and back to the negative recharge terminal 404. Accordingly, the recharge protection circuit 306 forms the current-guiding loop L3, inside the controller 300, to protect the battery module 400 against an unexpected current when the battery module 400 is in the protective state.

The aforesaid paragraph discloses a current-guiding way for ensuring the safety of the battery module; however, the invention is not limited to the current-guiding way. In another embodiment, the invention utilizes a way of clamping the voltage level difference between the first pin P1 and the third pin P3 within a predetermined level difference, in order to protect the battery module 400 and prevent unwanted recharge problems.

Please refer to FIG. 2B, which is a block diagram illustrating a controller 300′ according to a second embodiment of the invention. The main difference between the controller 300′ in the second embodiment and the controller 300 in the first embodiment is that the controller 300′ in FIG. 2B includes a voltage-clamping circuit 306′, which is coupled to the first pin P1 and the second pin P2. The voltage-clamping circuit 306′ is configured to force a level of the first pin P1 to be equal to or higher than a level of the third pin minus a predetermined level difference, i.e. Vp1≧Vp3−Vset, wherein Vp1 is the level of the first pin P1, Vp3 is the level of the third pin P3, and Vset is the predetermined level difference, which is positive. In practical applications, Vset can be set based on the threshold voltage of the parasitic diode 304a of the sampling switch unit 304.

The voltage-clamping circuit 306′ is utilized to limit the voltage level difference between the first pin P1 and the third pin P3, so as to avoid the leakage current loop based on the operational circuits (e.g. the parasitic diode 304a of the sampling switch unit 304 and the sampling resistor 305) inside the controller 300.

In this embodiment, the voltage-clamping circuit 306′ may further include a voltage-clamping unit 306b′ and a switch unit 306a′. The voltage-clamping unit 306b′ detects levels of the first pin P1 and the third pin P3. When the level of the first pin P1 is lower than the level of the third pin P3 minus the predetermined level difference, the voltage-clamping unit 306b′ switches on the switch unit 306a′ and adjusts equivalent resistance of the switch unit 306a′. Accordingly, the level of the first pin P1 is elevated, such that the level of the first pin P1 will not be far below the level of the third pin P3.

In aforesaid embodiments, the invention utilizes a way of current-guiding or voltage-clamping for protecting the battery module. In aforesaid embodiments, the switch units (such as the sampling switch unit 304, the switch unit 306a, and the switch unit 306a′, etc) take N-channel Metal Oxide Semiconductors (NMOS) for example. In aforesaid demonstration example, the recharge switch unit 401 is coupled between the negative terminal of the battery module 400 and the negative recharge terminal 404, and the first pin P1 is coupled to the negative recharge terminal 404. However, the invention is not limited to this.

In another embodiment, aforesaid switch units utilize P-channel Metal Oxide Semiconductors (PMOS) instead. Besides, the recharge switch unit is coupled between the positive terminal of the battery module and the positive recharge terminal. In this case, the controller in the invention can achieve similar effect by adjusting positive/negative connection logic. The corresponding logical adjustment is known by people in art.

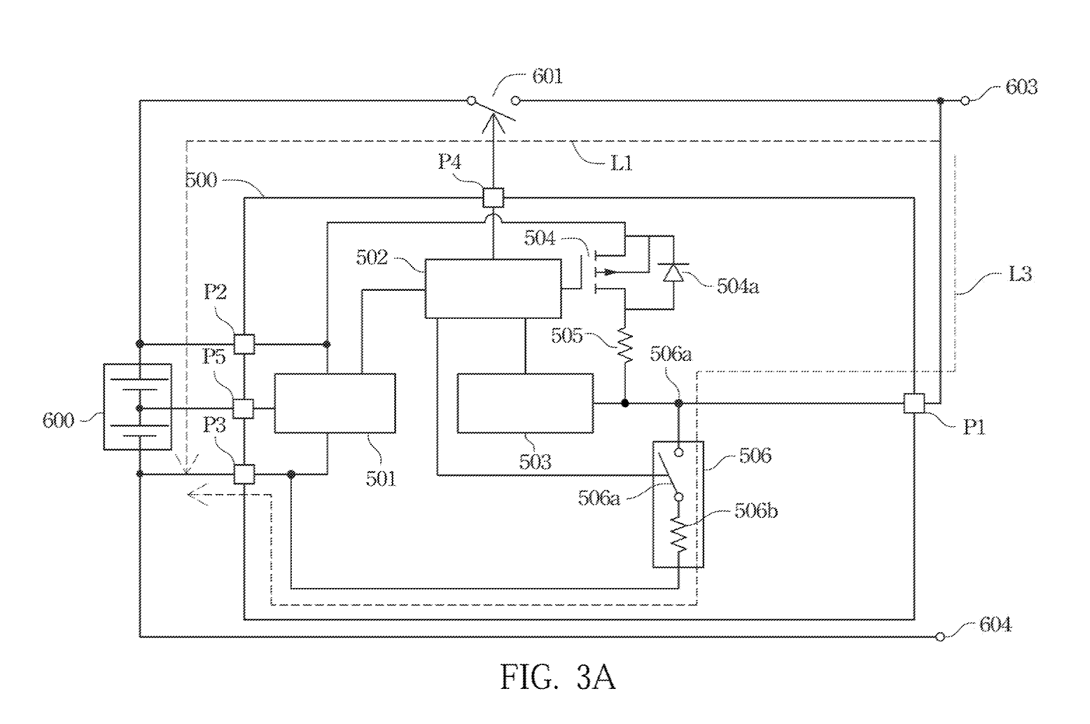

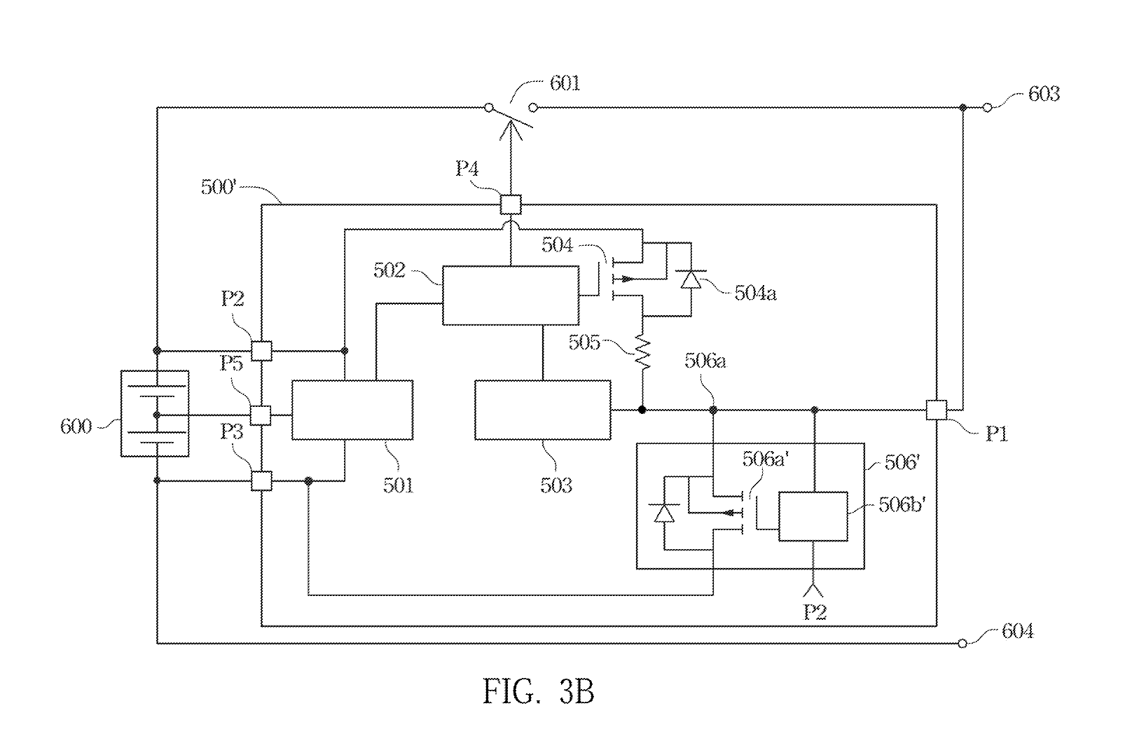

Please refer to FIG. 3A and FIG. 3B. FIG. 3A is a block diagram illustrating a controller 500 for protecting a battery module 600 according to a third embodiment of the invention. FIG. 3B is a block diagram illustrating a controller 500′ for protecting a battery module 600 according to a fourth embodiment of the invention.

As shown in FIG. 3A, the controller 500 includes a first pin P1, a second pin P2, a third pin P3, a fourth pin P4, a fifth pin P5, a voltage detection unit 501, a control logic unit 502, a current detection 503 and a recharge protection circuit 506. Besides, the controller 500 further includes internal operational circuits coupled between the first pin P1 and the second pin P2, e.g. a sampling switch unit 504 and a sampling resistor 505. In this embodiment, the battery module 600 includes two battery cells. The voltage detection unit 501 is coupled to two battery cells battery of the battery module 600 via the second pin P2, the third pin P3 and the fifth pin P5, for monitoring voltage states of each battery cell of the battery module 600 and judging if a protective action is needed.

In the embodiment, a recharge switch unit 601 is coupled between a positive terminal of the battery module 600 and the positive recharge terminal 603. The first pin P1 is coupled to the positive recharge terminal 603. The second pin P2 is coupled between a positive terminal of the battery module 600 and the positive recharge terminal 603. The third pin P3 is coupled between the negative terminal of the battery module 600 and the negative recharge terminal 604.

The recharge protection circuit 506 is coupled to the first pin P1 and the third pin P3. When the battery module 600 is in a protective state, the recharge protection circuit 506 is activated, such that an in-flowing current at the first pin P1 goes through a switch unit 506a and a resistor 506b of the recharge protection circuit 506, and then the current flows out via the third pin P3 back to the negative recharge terminal 604 (shown as the current-guiding loop L3 in FIG. 3A). In this way, the recharging current from the positive recharge terminal 603 skips the battery module 600 and is guided through the first pin P1, the recharge protection circuit 506, the third P3 and back to the negative recharge terminal 604. Accordingly, the recharge protection circuit 506 forms the current-guiding loop L3, inside the controller 500, to protect the battery module 600 against an unexpected current when the battery module 600 is in the protective state.

The operation and detail structure of the controller 500 in the third embodiment substantially has a corresponding and logic-opposite relationship to the controller 300 in the first embodiment. It can be easily understood by a person in the art.

On the other hand, the controller 500′ in the fourth embodiment shown in FIG. 3B implements a voltage-clamping circuit 506′. The voltage-clamping circuit 506′, which is coupled to the first pin P1 and the third pin P3. The voltage-clamping circuit 506′ is configured to force a level of the first pin P1 to be equal to or lower than a level of the second pin P2 plus a predetermined level difference, i.e. Vp1≦Vp2+Vset, wherein Vp1 is the level of the first pin P1, Vp2 is the level of the second pin P2, and Vset is the predetermined level difference, which is positive. In practical applications, Vset can be set based on the threshold voltage of the parasitic diode 504a of the sampling switch unit 504.

The detail structure and operation of the controller 500′ in the fourth embodiment is similar to the controller 300′ in the second embodiment, so not to be repeated here. Please refer to the paragraphs about the detail description of the controller 300′ in the second embodiment.

Aforesaid embodiments has demonstrates the recharge protection of the controller in the invention. To be emphasized that, some common operational circuits in the integrated circuit applied to the recharging apparatus may occur an unexpected current, and it may cause the unwanted recharge effect. For example, an electrostatic discharge (ESD) protection circuit is disposed in the integrated circuit (IC) for preventing that an ESD pulse (e.g. high voltage pulse signal) caused by ESD effect from damaging the internal circuits of the controller. The ESD protection circuit is active during the battery recharging procedure. If the positive recharge terminal level exceeds the positive terminal level of the battery module plus a predetermined level difference, or if the negative recharge terminal level is below the negative terminal level of the battery module minus a predetermined level difference, there may an unexpected leakage current, which flows through the ESD protection circuit and keeps on recharging the battery module. The current-guiding/voltage-clamping function of the recharge protection circuit disclosed in aforesaid embodiments can be used to solve the unexpected leakage current and the unwanted recharging problem as well.

According to the embodiments of the invention, the battery module and the controller are free from unexpected current or voltage signal (over-charging issue or ESD issue) by utilizing a current-guiding mean to make sure the leakage current bypass the battery module, or utilizing a voltage-clamping mean to prevent the unwanted current leakage. Therefore, the safety and durability in battery recharge procedure can be ensured.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A controller with battery recharge protective function, comprising:
a first pin coupled to a positive recharge terminal;
a second pin coupled to a positive terminal of a battery module;
a third pin coupled to a negative terminal of the battery module; and
a recharge protection circuit coupled to the first pin and the third pin, when the battery module is in a protective state, the recharge protection circuit being activated, such that an in-flowing current at the first pin goes through the recharge protection circuit and out-flows via the third pin.

2. The controller with battery recharge protective function of claim 1, wherein the recharge protection circuit comprises a voltage-clamping unit to make a level of the first pin to be equal to or lower than a sum of a level of the second pin and a predetermined level difference when the recharge protection circuit is activated, wherein the predetermined level difference is positive.

3. The controller with battery recharge protective function of claim 1, further comprising an electrostatic discharge protection circuit coupled between the first pin and the second pin.

4. The controller with battery recharge protective function of claim 2, further comprising an electrostatic discharge protection circuit coupled between the first pin and the second pin.

5. A controller with battery recharge protective function, comprising:
a first pin coupled to a negative recharge terminal;
a second pin coupled to a positive terminal of a battery module;
a third pin coupled to a negative terminal of the battery module; and
a recharge protection circuit coupled to the first pin and the second pin, when the battery module is in a protective state, the recharge protection circuit being activated, such that an out-flowing current at the first pin in-flows from the second pin and goes through the recharge protection circuit, so as to out-flow via the first pin.

6. The controller with battery recharge protective function of claim 5, wherein the recharge protection circuit comprises a voltage-clamping unit to make a level of the first pin to be equal to or higher than a level of the third pin minus a predetermined level difference when the recharge protection circuit is activated, wherein the predetermined level difference is positive.

7. The controller with battery recharge protective function of claim 5, further comprising an electrostatic discharge protection circuit coupled between the first pin and the third pin.

8. The controller with battery recharge protective function of claim 6, further comprising an electrostatic discharge protection circuit coupled between the first pin and the third pin.

9. A controller with battery recharge protective function, comprising:
a first pin coupled to a positive recharge terminal;
a second pin coupled to a positive terminal of a battery module;
a third pin coupled to a negative terminal of the battery module; and
a voltage-clamping circuit coupled to the first pin and the third pin, the voltage-clamping circuit being configured to maintain a level of the first pin to be equal to or lower than a sum of a level of the second pin and a predetermined level difference, wherein the predetermined level difference is positive.

10. The controller with battery recharge protective function of claim 9, wherein the voltage-clamping circuit comprises a voltage-clamping unit and a switch unit, and the switch unit is switched-on when the level of the first pin is higher than the level of the second pin plus the predetermined level difference.

11. The controller with battery recharge protective function of claim 10, wherein an in-flowing current at the first pin goes through the voltage-clamping circuit and out-flows via the third pin when the switch unit is switched-on.

12. A controller with battery recharge protective function, comprising:
a first pin coupled to a positive recharge terminal;
a second pin coupled to a positive terminal of a battery module;
a third pin coupled to a negative terminal of the battery module; and
a voltage-clamping circuit coupled to the first pin and the second pin, the voltage-clamping circuit being configured to maintain a level of the first pin to be equal to or higher than a level of the third pin minus a predetermined level difference, wherein the predetermined level difference is positive.

13. The controller with battery recharge protective function of claim 12, wherein the voltage-clamping circuit comprises a voltage-clamping unit and a switch unit, and the switch unit is switched-on when the level of the first pin is lower than the level of the third pin minus the predetermined level difference.

14. The controller with battery recharge protective function of claim 13, wherein an out-flowing current at the first pin in-flows from the second pin and goes through the recharge protection circuit, so as to out-flow via the first pin when the switch unit is switched-on.
